SEQUENCE LISTING (1 sequence)

SEQ ID NO: 1 - DNA, 34 bp, Artificial Sequence
  Description of Artificial Sequence Synthetic oligonucleotide
ggggcacgtttatccgtccctagtggcgtgcccc

(19) United States
(12) Patent Application Publication
(10) Pub. No.: US 2008/0223121 A1
(43) Pub. Date: Sep. 18, 2008

(54) APTAMER PROBE FOR LOCATING MOLECULES AND METHOD OF USE

(76) Inventors: Liyun Lin, Chandler, AZ (US); Hao Yan, Chandler, AZ (US); Yan Liu, Chandler, AZ (US); Stuart Lindsay, Phoenix, AZ (US)

Correspondence Address: KENYON & KENYON LLP, RIVERPARK TOWERS, SUITE 600, 333 W. SAN CARLOS ST., SAN JOSE, CA, 95110, US

(21) Appl. No.: 11/948,960

(22) Filed: Nov. 30, 2007

Related U.S. Application Data
(60) Provisional application No. 60/868,295, filed on Dec. 1, 2006.
(60) Provisional application No. 60/869,079, filed on Dec. 7, 2006.

(51) Int. Cl. G01B 5/28

(52) U.S. Cl. 73/105

(57) ABSTRACT

An atomic force microscope and a method for detecting interactions between a probe and at least one sensed agent on a scanned surface is provided. The microscope has a scanning probe with a tip that is sensitive to a property of said scanned surface; a nucleic acid aptamer tethered to the tip of the probe; and a device for simultaneously recording the displacement of said probe tip as a function of time, topographic images, and the spatial location of interactions between said probe and the at least one sensed agent on said surface.

### CROSS REFERENCE TO RELATED APPLICATIONS

The present application claims priority to U.S. Provisional Applications Ser. No. 60/868,295 filed Dec. 1, 2006 and Ser. No. 60/869,079 filed on Dec. 7, 2006, which are incorporated herein by reference in their entirety.

### STATEMENT OF GOVERNMENT SUPPORT

The work herein was supported in part by NIH grant CA 85990 and NSF grants CCF-0453686 and CCF-0453685; thus the United States Government may have certain rights to this invention.

### FIELD OF THE INVENTION

Aspects of the present invention relate to recognition imaging. More specifically, aspects of the present invention relate to using an oscillating probe with a bound ligand to scan a surface and map the location of a chemical entity recognized by the ligand.

### BACKGROUND OF THE INVENTION

Atomic force microscopes (AFMs) are capable of producing images at molecular resolutions in water, making them a useful tool for biological and chemical imaging. AFMs, however, are limited because when complex samples are imaged, it is nearly impossible to differentiate between proteins of the same molecular weights from the topographical image alone.

Recognition imaging is a technique that can give an AFM chemical sensitivity. U.S. Pat. No. 7,152,462, which is herein incorporated by reference in its entirety, discloses an atomic force microscope having an antibody tethered to the probe tip. The antibody tethered to an oscillating AFM sensing probe, binds to its antigen and changes the pattern of oscillation as the probe is scanned over the surface. A map of these changes, superimposed onto the topographic image, can show where the target proteins are located in the image. Using antibodies as sensing agents, however, presents problems. Antibodies, being natural proteins, can be difficult to work with. Known methods for attachment involve modifying lysine groups, which potentially alters the antibody's function. Antibodies also often are not good at recognizing small organic molecules.

Accordingly, there is a need in the art for an improved kind of recognition molecule that can be used as a sensing agent.

### SUMMARY OF THE INVENTION

The present invention provides an improved atomic force microscope for detecting interactions between a probe and at least one sensed agent on a scanned surface, having a scanning probe with a tip that is sensitive to a property of the scanned surface; a nucleic acid aptamer tethered to the tip of the probe; and a device for simultaneously recording the displacement of the probe tip as a function of time, topographic images, and the spatial location of interactions between the probe and the at least one sensed agent on the surface.

The present invention also provides a method for using an improved atomic force microscope by providing a scanning probe having a tip that is sensitive to a property of the surface, the tip being bound to a nucleic acid aptamer; placing the probe tip near the surface; allowing the probe tip to oscillate in response to sensing at least one agent on the surface; recording a displacement of the probe tip as a function of time; recording a plurality of topographic images; recording a spatial location of interactions between the probe and one or more sensed agents on the surface.

### BRIEF DESCRIPTION OF THE DRAWINGS

FIG. 1 shows a microscope probe embodying aspects of the present invention.

FIG. 2 shows a microscope probe embodying aspects of the present invention.

FIGS. 3a-e show topography and recognition signals for images acquired using methods embodying aspects of the present invention.

FIGS. 4a-c show recognition images of a field of IgE molecules, histograms of the pixel intensity distribution for (upper) an area without a recognition spot and (lower) an area with a recognition spot.

FIG. 5 shows a histogram of pull-off forces for an aptamer binding IgE molecules.

### DETAILED DESCRIPTION OF THE DRAWINGS

The disadvantages of using antibodies as sensing agents can be overcome with a different and simpler recognition/sensing agent. The simpler recognition/sensing agent can be used in conjunction with an atomic force microscope and method of operating it that provides separate yet simultaneous topography and recognition images as well as rapid quantitative measurement of molecular interactions with high spatial resolution. The present invention may be useful in providing high spatial resolution of many physical, chemical, and biological interactions on both hard and soft surfaces. In accordance with one aspect of the present invention, a recognition force microscope for detecting interactions between a probe and a sensed agent on a scanned surface is provided and can include a scanning probe having a tip that is sensitive to a property of a surface, with the probe adapted to oscillate with a low mechanical Q factor (i.e. the quality factor of a cantilever probe), where Q=f₁/Δf₁, where f₁ is the first resonance frequency of the cantilever and Δf₁ is the full width of the resonance peak at half-maximum. “Low mechanical Q factor” can mean a Q factor of greater than zero and equal to or less than about 20. The Q factor of the cantilever can be determined by the stiffness of the cantilever and the viscosity of the medium in which it oscillates, and also, to some extent, by the geometry of the cantilever. A Q factor of about equal to or less than 20 can be typical of what might be measured for cantilevers having a stiffness of a few Newtons per meter oscillated in water, which can be typical conditions used for imaging biological materials with an atomic force microscope (AFM).

The microscope can also include a means for recording the displacement of the probe tip as a function of time and means for recording both topographical data and recognition data, i.e. the spatial location of interactions between the probe and sensed agents on the surface. The means for recording the displacement of the probe tip as a function of time can include a source of radiation such as a laser that is directed at the probe, a position sensitive detector that detects radiation reflecting off of the surface of the probe, and a controller that processes the detected radiation. The means for recording both the topographical and recognition data can include processing circuitry that generates separate topographical and recognition signals. The amplitudes of the respective upward and downward swings (displacements) of the probe tip can be recorded and used to determine both topographic data and recognition data to identify the spatial location of interaction sites between the probe tip and sensed agents on a sample surface.

The probe tip can be sensitized with a sensing agent that binds specifically to the sensed agent. The sensing agent can be tethered to the probe tip by a flexible crosslinker (i.e., a chemical agent that binds the sensing agent to the probe tip). However, the apparatus and methods of the present invention are not limited to molecular binding or bonding but can also include other chemical and physical interactions such as electrostatic charge interactions and hydrophobic/hydrophilic interactions. Thus, the “sensing agent” on the probe tip may include electrical and/or chemical modifications to the tip as well as tethering of molecules to the tip.

A time varying magnetic field can be used to excite the probe into motion using a magnetic material that forms at least a portion of the probe. The topographic and recognition data signals that are detected and recorded can be separated by an electronic circuit that includes means for determining the average value of the displacement of the probe (for example, by using a deflection signal generated from the position sensitive detector) on a time scale that is sufficiently long compared to changes caused by topography or binding events such that those events can be separately recognized and measured. The electronic circuit can also include means for using the average value of the displacement of the probe to determine the downward amplitude of the probe from the difference between the average value and the value of the downward displacement. These means can include a digital signal processor operating using a recognition-imaging algorithm.

The electronic circuit can also include means for controlling the height of the probe. The means for controlling the height of the probe might include a piezoelectrically driven scanning element in conjunction with a controller. Thus, topography can be determined using the downward value of the probe tip displacement. The electronic circuit can also include means for determining the value of the upward displacement of the probe from the measured amplitude and the average value of the displacement to generate a signal corresponding to interactions between a sensing agent and a sensed agent on the surface being scanned. The means for determining these values might include a digital signal processor operating using a recognition-imaging algorithm.

The topographic and recognition signals can be separated by an electronic circuit that includes means for digitizing the recorded deflection of the probe tip and computing means for determining the average value of the displacement of the probe tip on a time scale that is sufficiently long compared to changes caused by topography or binding events such that those events are separately recognized and measured. The digitizing means might include one or more A/D converters. The electronic circuit can also include means for using the average value of the displacement of the probe to determine the downward amplitude from the difference between the average value and the value of downward displacement. The means for determining these values might include a digital signal processor operating using a recognition-imaging algorithm.

The electronic circuit can also include means for controlling the height of the probe to determine the topography of the sample using the value of downward displacement and means for determining the value of the upward displacement from the upward amplitude and the average value of displacement to generate a signal corresponding to interactions between a sensing agent on the probe tip and a sensed agent on the surface being scanned.

The probe tip displacement can be measured as a function of time used to determine the spatial location of recognition events by comparison to a predicted or recorded displacement pattern generated for the case when there is no recognition.

The present invention also provides a method of operating an atomic force microscope which can include scanning a probe oscillating with a low mechanical Q factor that is sensitive to a property of a surface, recording the displacement of the probe tip as a function of time, and simultaneously recording both topographical images and the spatial location of interactions between the probe and sensed agents on the surface of a sample. The method can use the extent of the upward displacement of the probe tip to measure interactions between the probe tip and the sample surface. The height of the probe tip above the sample surface can be controlled by using either the extent of the downward displacement of the probe tip (i.e., bottom amplitude), the overall amplitude of the probe tip (i.e., the sum of the upper and lower amplitudes of the tip divided by two), or the average deflection signal (i.e., the difference between the upper and lower amplitudes of the tip).

In another embodiment of the invention, a method for screening reagents for binding to a particular target molecule is provided and can include attaching the target molecule to the tip of a probe, scanning at least one candidate reagent with an oscillated force-sensing probe operating with a low mechanical Q factor, using the extent of the downward displacement of the probe to control the height of the probe above the sample surface, and using the extent of the upward displacement to measure interactions between the target molecule and the candidate reagent. The method can used to screen for multiple candidate reagents sequentially. For example, the candidate reagents can be placed in an array and sampled sequentially.

In yet another embodiment of the invention, a method of screening ligands for binding to a particular target on a cell surface is provided and can include attaching the ligand to the tip of a probe, scanning a cell surface with an oscillated force-sensing probe operated with a low mechanical Q factor, using the extent of the downward displacement to control the height of the probe above the sample surface, and using the extent of the upward displacement to measure interactions between at least one target molecule on the cell surface and the candidate ligand.

Accordingly, it is a feature of the present invention to provide an atomic force microscope and method of operating it that provides separate and simultaneous topography and recognition images as well as rapid quantitative measurement of molecular binding with high spatial resolution. This and other features and advantages of the invention will become apparent with the reference to the accompanying figures and the appended claims.

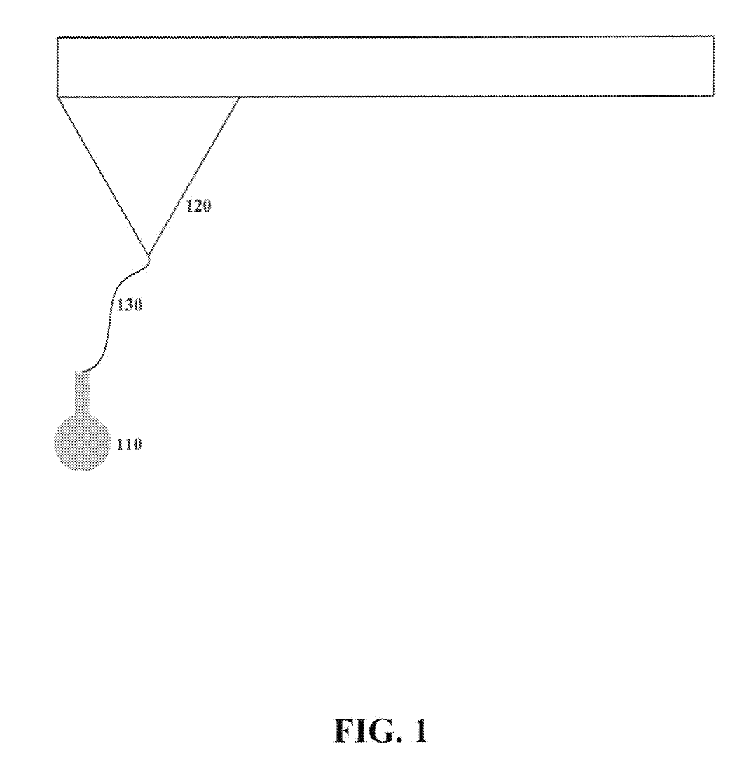

The present invention uses an aptamer as the preferred sensing agent. An aptamer is defined as a nucleic acid aptamer (DNA or RNA) that binds to a specific target molecule. An aptamer can be selected, for example, by a process known as Systematic Evolution Of Ligands by Exponential Enrichment (SELEX). FIG. 1 shows an aptamer 110 tethered to an AFM probe 120 via a PEG (polyetheylene glycol) linker 130. The aptamer 110 may be used as a recognition element on the end of the AFM probe 120 in order to generate images that show the location of chemical entities recognized by the aptamer 110. An aspect of the present invention involves using an aptamer 110 tethered to an AFM probe 120 via a specific chemical linkage 130 (such as a thiol terminated aptamer linked to a maleimide containing tether on the AFM probe) as an agent for forming recognition images. The aptamers 110 show a remarkable improvement in signal to noise ratio and selectivity over antibodies used in the same application. The tethering chemistry and preparation of aptamers are also much more straightforward than that of antibodies.

Aptamers can be attached to an AFM probe and used to generate recognition signals that are efficient (>90%) and specific, recognizing even a small amount of a target protein in a sample composed predominantly of another protein. Chemically simpler than antibodies, aptamers can permit mapping of even quite small differences in the composition of proteins. Also, while an aptamer may not bind to its target more strongly than an antibody, it gives a better signal, suggesting that non-specific adhesion is lower.

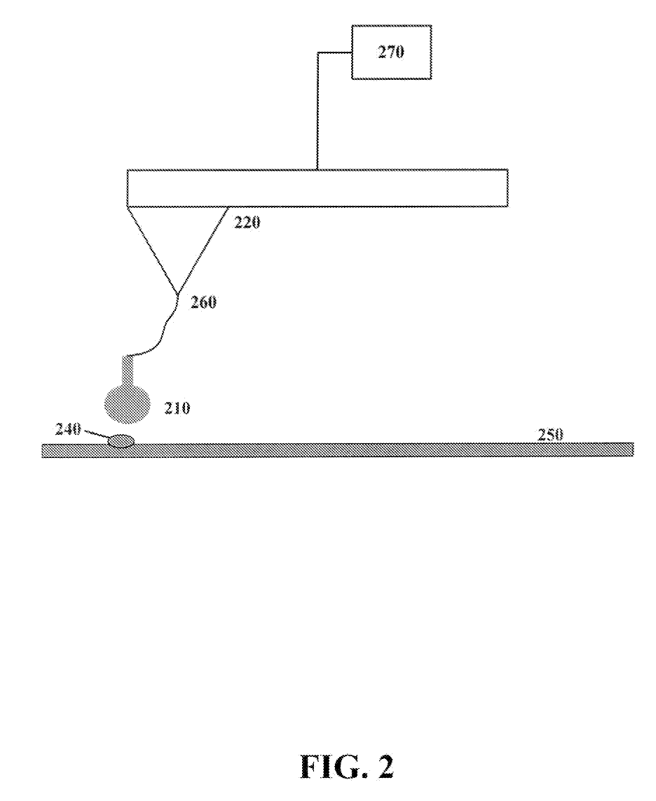

FIG. 2 shows a portion of a recognition force microscope embodying another aspect of the present invention. A recognition force microscope can detect interactions between a probe 220 and a sensed agent 240 on a scanned surface 250. The recognition force microscope may have a scanning probe 220 with a tip 260 that is sensitive to a property of the scanned surface 250. The probe 220 may be adapted to oscillate with a low mechanical Q factor.

A “Q factor” is defined as Q=f₁/Δf₁, where f₁ is the first resonance frequency of the cantilever and Δf₁ is the full width of the resonance peak at half-maximum. A “low mechanical Q factor” is a Q factor of greater than zero and equal to or less than about 20. The Q factor of the cantilever is determined by the stiffness of the cantilever and the viscosity of the medium in which it oscillates, and also, to some extent, by the geometry of the cantilever. A Q factor of about equal to or less than 20 is typical of what might be measured for cantilevers having a stiffness of a few Newtons per meter oscillated in water. This is typical of the conditions used for imaging biological materials with an atomic force microscope (AFM).

The microscope includes apparatus 270 to record displacement of the probe tip 260 as a function of time, and to record both topographic images and the spatial location of interactions between the probe and one or more sensed agents 240 on the surface and a nucleic acid aptamer 210 bound to the probe tip 260.

According to another aspect of the invention, an atomic force microscope may be operated to detect interactions between a probe and a sensed agent on a scanned surface. The probe may be as described above. The microscope may have recording apparatus as described above.

In another aspect of the present invention, an aptamer is tethered to an atomic force microscope probe to carry out recognition imaging, for example, recognition imaging of IgE molecules attached to a mica substrate. Methods of implementing embodiments of the present invention can be efficient and specific, being blocked by injection of IgE molecules in solution, and not being interfered with by high concentrations of a second protein. The signal-to-noise ratio of the recognition signal is better than that obtained with antibodies, despite the fact that the average force required to break the aptamer-protein bonds is somewhat smaller.

DNA aptamers can be small stem-loop single stranded DNA molecules generated via SELEX. Though not as common as antibodies, an aptamer sequence, once identified, is easy to use. Aptamers may comprise or consist of a single strand of DNA or RNA, so they are easy to synthesize and store. The nucleic acids can be folded by thermal annealing in an appropriate buffer and can also be attached to an AFM probe using commercially-available DNA that is chemically modified at one end. In contrast, the present process for attaching antibodies to the probe relies on modification of available lysines, a procedure that carries the risk of altering the variable region of the antibody.

Aptamers may be more specific than antibodies. They can also have a high affinity for some small molecules, which can allow them to recognize imaging of minor chemical modifications which might, for example, be important as components of an epigenetic code. An aspect of the present invention, therefore, calls for using aptamers as ligands for recognition imaging because they can be highly specific in the presence of large amounts of exogenous protein.

One embodiment of the present invention may use an aptamer to Human IgE because this has been shown to produce significant specific adhesion in AFM force curves. The aptamer may be attached to the AFM probe by a linker, which can allow free movement of the aptamer with respect to the probe, thus improving binding. A short linker (e.g. 1 to 10 nm) may be preferred in order to minimize resolution degradation. Any linker suitable for use in these embodiments can be used. For example, AFM probes may be aminated and functionalized with a heterobifunctional polyethylene glycol, including but not limited to Mal-d(PEG)12-NHS ester (for example, from Quanta Biodesign, Powell, Ohio) leaving the thiol-reactive maleimide at the end of the PEG.

In another non-limiting embodiment, the thiolated molecule 5′-GGGGCACGTTTATCCGTCCCTAGTGGCGTGCCCC/3ThioMC3-D/-3′ (SEQ ID NO: 1) (for example, from Integrated DNA Technologies, Coralville, Iowa) can be purified by polyacrylamide gel electrophoresis followed by ethanol precipitation, then re-suspended and attached to a PEG-based linker to form a construct such as shown in FIG. 1. PEG-based linkers can have the particular advantage of minimizing adhesion between the aptamer and the AFM probe. In various further non-limiting embodiments, the linker can comprise alkane chains, polyelectrolytes such as poly(sodium styrene sulfonate) (PSS), and poly(acrylic acid) (PAA). Other aspects of the procedure are similar to those used in antibody attachment, as known to those of ordinary skill in the art.

Glutaraldehyde-modified mica substrates can be prepared, as known to those of ordinary skill in the art, and 70 μL of a 0.01 μM solution of IgE (for example, from Athens Research, Athens, Ga.) in MPBS buffer (PBS buffer with 1 mM Mg2±ref8) can be left on the substrate for a period of time, such as 40 min. After rinsing, the sample may be placed under an MPBS buffer and imaged immediately using a microscope equipped for recognition imaging, such as the PicoPlus with PicoTREC from Agilent Technologies, Inc.

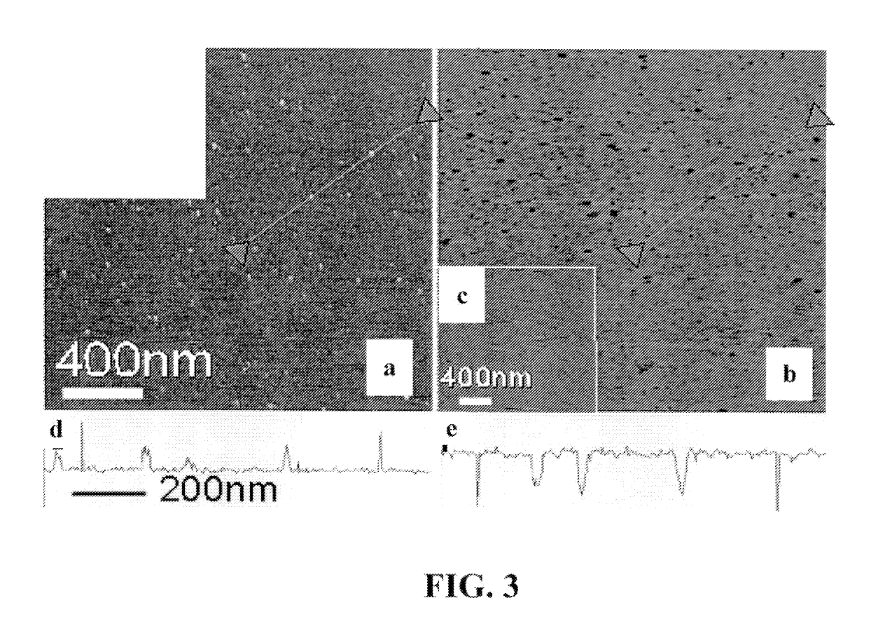

A typical topographic image is shown in FIG. 3a with the simultaneously-acquired recognition image shown in FIG. 3b. The dark spots in the recognition image mark regions where the aptamer bonded, and these are coincident with the location of IgE molecules, as can be seen by comparing a cross-sectional trace across the images (see the topography of FIG. 3d and the recognition of FIG. 3e). The signal to noise in the recognition signal is better than previously reported for antibodies. The aptamer can be blocked by flowing 70 μL of a 0.01 μM solution of IgE in MPBS into the liquid cell of the microscope. When the same region of the substrate is re-imaged (see FIG. 3c), the recognition signal can be abolished, indicating that the interaction was specific.

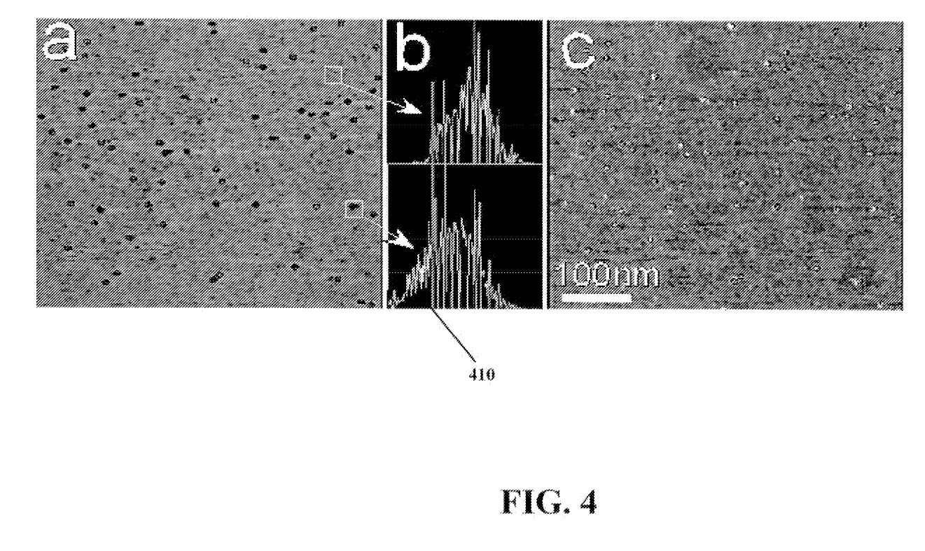

A custom image analysis program may be used to quantify the recognition further. Another recognition image of a field of IgE molecules is shown in FIG. 4a. The distribution of pixel intensities both away from, and including a recognition spot are shown in FIG. 4b. A clear separation exists between the recognition signal level and the background signal (see line 410 on FIG. 4b), and this level may be used to determine legitimate spots (which may be marked by circles placed around them by the analysis program). The markers may be transferred onto the topographic image (FIG. 4c) so that recognized features can be identified. The use of this procedure may include careful leveling of the background, and it may be enhanced by a 3×3 median filter that removes noise spikes on individual pixels.

The number of protein-like features recognized in the example of FIG. 4a is 76 out of 84 total features in the topographic image that have a size that indicates that they are IgE molecules. This 90% recognition level is typical for pure preparations of IgE, indicating that the IgE is commonly oriented with its recognition site exposed. To test for selectivity in the presence of an interfering protein, surfaces treated with either a mixture of thrombin and IgE (60:1 molar ratio) or with just pure thrombin may be imaged. It may be determined that no recognition events on the surface functionalized with only thrombin can be found. In the example of FIG. 4, the mixed surface gave 23 recognition events out of approximately 300 spots that could have been either thrombin or IgE. This 13:1 ratio is somewhat greater than the molar ratio of the two proteins in the solution used. IgE may adsorb onto the surface preferentially.

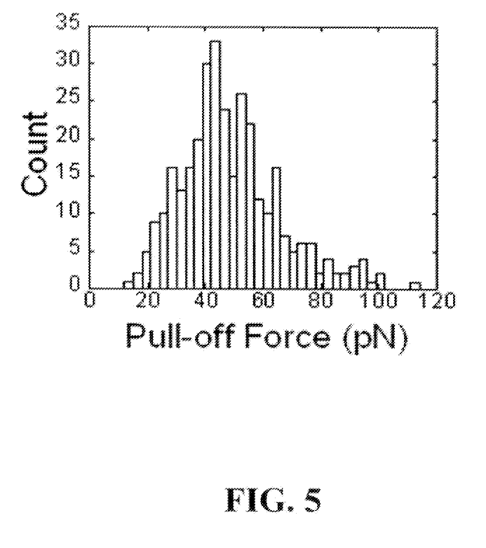

Linking the aptamer directly to the AFM tip and suspending the ligand from a PEG linker can result in different adhesion properties. Importantly, the characteristics of the pull-off curve allow unambiguous identification of single molecule data resulting from the characteristic stretching of the PEG. The improved signal-to-noise in the recognition signal (relative to that obtained with antibodies) might be expected to reflect a relatively stronger binding of the aptamer as indicated by force-curve data. A histogram of the distribution of pull-off forces for the aptamer is shown in FIG. 5. The median pull-off force is smaller than that obtained with antibodies, and there exists only a small difference between the pull-off force for the aptamer (160 pN) and for the antibody (140 pN), making it unlikely that the enhanced recognition signal could be accounted for simply by better binding of the aptamer.

The previous description of embodiments is provided to enable a person skilled in the art to make and use the present invention. Various modifications to these embodiments will be readily apparent to those skilled in the art, and the generic principles and specific examples defined herein may be applied to other embodiments without the use of inventive faculty. For example, while the specific compounds and chemicals mentioned above reflect work actually accomplished and results obtained, in this specification these parameters are provided merely as examples, and it may be readily apparent to those skilled in the art that different chemicals and compounds can be used without the use of inventive faculty and without deviating from the spirit of the description provided. Therefore, the present invention is not intended to be limited to the embodiments specifically described herein but is to be accorded the widest scope consistent with the entirety of the disclosure and the associated figures.

What is claimed is:

1. A recognition force microscope for detecting interactions between a probe and a sensed agent on a scanned surface, comprising:
a scanning probe having a tip that is sensitive to a property of said surface, said probe adapted to oscillate with a low mechanical Q factor;
a mechanism to record the displacement of said probe tip as a function of time; and
a mechanism to record both topographic images and spatial location of interactions between said probe and one or more sensed agents on said surface; and
a nucleic acid aptamer bound to said probe.

2. An atomic force microscope for detecting interactions between a probe and at least one sensed agent on a scanned surface, comprising:
a scanning probe having a tip that is sensitive to a property of said scanned surface;
a nucleic acid aptamer tethered to the probe tip; and
a mechanism to record a displacement of said probe tip as a function of time, recording topographic images, and recording spatial location of interactions between said probe and the at least one sensed agent on said surface.

3. The atomic force microscope of claim 2, wherein the probe is not bound to any antibodies.

4. The atomic force microscope of claim 2, wherein the aptamer is a DNA aptamer.

5. The atomic force microscope of claim 2, wherein the aptamer is a RNA aptamer.

6. The atomic force microscope of claim 2, wherein the aptamer is generated by SELEX (Systematic Evolution of Ligands by Exponential Enrichment).

7. The atomic force microscope of claim 2, wherein the aptamer is formed by folding and annealing a nucleic acid.

8. The atomic force microscope of claim 2, wherein said probe is adapted to oscillate with a low mechanical Q factor.

9. The atomic force microscope of claim 8, wherein the mechanical Q factor is less than about 20.

10. The atomic force microscope of claim 2, wherein the aptamer is tethered to the probe by a chemical specific linker.

11. The atomic force microscope of claim 2, wherein the aptamer is tethered to the probe by a polyethylene glycol linker.

12. A method of detecting interactions between a probe and at least one agent on a scanned surface comprising:
providing a scanning probe having a tip that is sensitive to a property of the surface,
binding the probe tip to a nucleic acid aptamer;
placing the probe tip near the surface;
allowing the probe tip to oscillate in response to sensing the at least one agent on the surface;
recording a displacement of said probe tip as a function of time;
recording a plurality of topographic images; and
recording a spatial location of interactions between said probe tip and the at least one agent on the surface.

13. The method of claim 12, further comprising determining where the at least one sensed agent is located on the scanned surface.

14. The method of claim 12, further comprising forming the aptamer by folding and annealing a nucleic acid before the step of binding the aptamer to the probe tip.
